(19) United States
(12) Patent Application Publication
(10) Pub. No.: US 2010/0088413 A1
(43) Pub. Date: Apr. 8, 2010

(54) License managing apparatus, license managing method, and license managing system

(75) Inventor: Ippei Nishimoto, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/586,935

(22) Filed: Sep. 30, 2009

(30) Foreign Application Priority Data
Oct. 2, 2008 (JP) P2008-257380

(51) Int. Cl. G06F 15/173

(52) U.S. Cl. 709/226

(57) ABSTRACT

A license managing apparatus includes: a license management section configured to issue a license in response to a request from an external device carrying an application to be activated using the license; a database configured to store ordinary license information indicating the number of ordinary licenses yet to be issued until a predetermined maximum number of ordinary licenses being held are exhausted, and overdraft license information indicating the number of overdraft licenses issued after the ordinary licenses have been exhausted; and a transmission section configured to transmit the license issued for the external device.

### CROSS-REFERENCE TO RELATED APPLICATION

The present application claims priority from Japanese Patent Application No. JP 2008-257380 filed in the Japanese Patent Office on Oct. 2, 2008, the entire content of which is incorporated herein by reference.

### BACKGROUND OF THE INVENTION

1. Field of the Invention

The present invention relates to a license managing apparatus, a license managing method, and a license managing system for managing the licenses needed to use applications.

2. Description of the Related Art

Heretofore, there have been generally adopted two systems, the volume charging system and the license purchasing system, whereby the same application is offered to a plurality of users in corporations, schools and other institutions.

According to the volume charging system, the number of users who will use the application is not limited. Instead, fees are charged for the number of times the application has been used and/or for the time period over which the application has been in use. Under this system, the users can use the application whenever necessary and as many times as needed. According to the license purchasing system, on the other hand, a required number of licenses are purchased beforehand. As long as the number of purchased licenses is not exceeded, a flat rate applies no matter how much the application has been used.

However, because fees are charged for how much the application has been in use according to the volume charging system, this system tends to be more expensive than the license purchasing system if the volume of license usage is inordinately large. Moreover, the amount of the fees charged is perpetually undecided under the volume charging system, so that it takes time and effort to handle the charges in financial terms.

Meanwhile, if the number of purchased licenses is exceeded under the license purchasing system, the functionality of the application may be limited or the use of the application itself may be inhibited. One way to overcome these problems is by resorting to the volume charging system when the number of purchased licenses is exceeded. JP-T-2006-517697 discloses a software license managing system utilizing such arrangements.

### SUMMARY OF THE INVENTION

However, the license managing system disclosed by the above-cited patent publication has its share of disadvantages. Like the volume charging system, the disclosed system is still subject to the inordinately high fees being charged for the application in use, and the considerable amount of time and effort being required in financial terms to handle the constantly undecided fees.

The present invention has been made in view of the above circumstances and provides a license managing apparatus, a license managing method, and a license managing system whereby the licenses needed to use applications are managed easily, with no need to deal with the above-mentioned problems.

In carrying out the present invention and according to one embodiment thereof, there is provided a license managing apparatus including: a license management section configured to issue a license in response to a request from an external device carrying an application to be activated using the license; a database configured to store ordinary license information indicating the number of ordinary licenses yet to be issued until a predetermined maximum number of ordinary licenses being held are exhausted, and overdraft license information indicating the number of overdraft licenses issued after the ordinary licenses have been exhausted; and a transmission section configured to transmit the license issued for the external device. Upon receipt of a license issuance request from the external device, the license management section references the ordinary license information to determine whether the ordinary licenses are still available. If the ordinary licenses are determined to be available, then the license management section decrements the ordinary license information numerically by 1 and issues one ordinary license to the external device via the transmission section. If the ordinary licenses are determined to have been exhausted, then the license management section increments the overdraft license information numerically by 1 and issues one overdraft license to the external device via the transmission section.

According to another embodiment of the present invention, there is provided a license managing method including the steps of: issuing a license in response to a request from an external device carrying an application to be activated using the license, by referencing a database configured to store ordinary license information indicating the number of ordinary licenses yet to be issued until a predetermined maximum number of ordinary licenses being held are exhausted, and overdraft license information indicating the number of overdraft licenses issued after the ordinary licenses have been exhausted; and transmitting the license issued for the external device. Upon receipt of a license issuance request from the external device, the license managing step references the ordinary license information to determine whether the ordinary licenses are still available. If the ordinary licenses are determined to be available, then the license managing step decrements the ordinary license information numerically by 1 and issues one ordinary license to the external device. If the ordinary licenses are determined to have been exhausted, then the license managing step increments the overdraft license information numerically by 1 and issues one overdraft license to the external device.

According to a further embodiment of the present invention, there is provided a license managing system including a device and a license managing apparatus. The device includes: a section configured to request issuance of a license needed to use an application carried by the device; and a first transmission section configured to transmit the license issuance request. The license managing apparatus includes: a license management section configured to issue a license in response to the request from the device; a database configured to store ordinary license information indicating the number of ordinary licenses yet to be issued until a predetermined maximum number of ordinary licenses being held are exhausted, and overdraft license information indicating the number of overdraft licenses issued after the ordinary licenses have been exhausted; and a second transmission section configured to transmit the license issued for the external device. Upon receipt of a license issuance request from the external device, the license management section references the ordinary license information to determine whether the ordinary licenses are still available. If the ordinary licenses are determined to be available, then the license management section decrements the ordinary license information numerically by 1 and issues one ordinary license to the external device via the second transmission section. If the ordinary licenses are determined to have been exhausted, then the license management section increments the overdraft license information numerically by 1 and issues one overdraft license to the external device via the second transmission section.

According to the above-outlined embodiments of the present invention, a license is issued in response to a request from an external device carrying an application to be activated using the license, by referencing a database storing ordinary license information indicating the number of ordinary licenses yet to be issued until a predetermined maximum number of ordinary licenses being held are exhausted, and overdraft license information indicating the number of overdraft licenses issued after the ordinary licenses have been exhausted. The license issued for the external device is transmitted to the latter. Upon receipt of a license issuance request from the external device, the ordinary license information is referenced to determine whether the ordinary licenses are still available. If the ordinary licenses are determined to be available, then the ordinary license information is decremented numerically by 1 and one ordinary license is issued to the external device. If the ordinary licenses are determined to have been exhausted, then the overdraft license information is incremented numerically by 1 and one overdraft license is issued to the external device. In this manner, even when the ordinary licenses have been exhausted, licenses can still be issued.

According to the embodiments of the present invention, an overdraft license is issued if the available ordinary licenses are found exhausted upon receipt of a license issuance request from the external device. This feature offers the advantage of being able to use the application continuously even when the previously purchased ordinary licenses have been exhausted.

Also according to the embodiments of the present invention, the cumulative time during which overdraft licenses have been used is calculated at predetermined intervals. When the calculated cumulative time is found to have exceeded a predetermined threshold value, the issuance of overdraft licenses is stopped and there are imposed penalties such as restrictions on the functionality of the application and a halt to the use of the application itself. This feature offers the advantage of preventing users from unscrupulously utilizing the application through the use of overdraft licenses.

### BRIEF DESCRIPTION OF THE DRAWINGS

FIG. 1 is a block diagram showing a typical configuration of a license managing system that may be practiced as one embodiment of the present invention;

FIGS. 2A, 2B and 2C are schematic views explanatory of how licenses are typically managed;

FIG. 3 is a graphic representation showing changes in the number of licenses in use at predetermined intervals;

FIG. 4 is a schematic view explanatory of an overdraft history;

FIG. 5 is a graphic representation showing typical cumulative time periods during which overdraft licenses have been used;

FIG. 6 is a schematic view explanatory of how the overdraft history is updated when ordinary licenses have been additionally purchased;

FIG. 7 is a flowchart explanatory of the steps in which an application is activated;

FIG. 8 is a flowchart explanatory of the steps in which the application is deactivated;

FIG. 9 is a flowchart explanatory of the steps in which to calculate the cumulative time during which overdraft licenses have been used; and

FIG. 10 is a flowchart explanatory of the steps in which ordinary licenses are additionally purchased.

### DETAILED DESCRIPTION OF THE PREFERRED EMBODIMENT

One preferred embodiment of the present invention will now be described by referring to the accompanying drawings. Upon receipt of a request for issuance of a new license after all previously purchased licenses have been issued, this embodiment of the invention issues a license usable up to a predetermined point in time in excess of the preceding licenses.

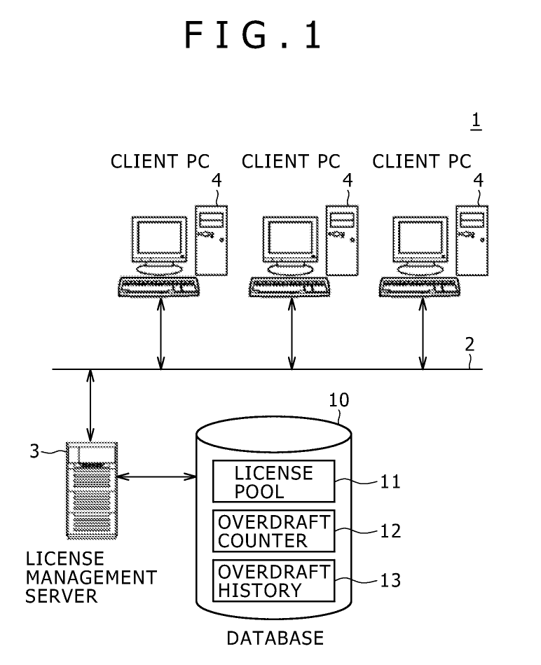

FIG. 1 is a block diagram showing a typical configuration of a license managing system 1 that may be practiced as one preferred embodiment of the present invention. The license managing system 1 includes a license management server 3 and client PCs (personal computers) 4, 4, etc., all connected on a network 2 such as a LAN (local area network). Although three client PCs 4 are shown connected in FIG. 1, this is not limitative of the present invention. Any desired number of client PCs may be configured in the system instead.

Each client PC 4 carries an application subject to license management. To utilize the application requires a license which gives permission to use and which is issued by the license management server 3, to be discussed later. For this reason, each client PC 4 uses a transmission section, not shown, to transmit a license issuance request to the license management server 3 through the network 2, to be described later. When stopping usage of the application, the client PC 4 uses the transmission section to transmit a license return request to the license management server 3 through the network 2. Licenses are exchanged between the license management server 3 and the client PC 4 in response to license issuance/return requests from the latter.

The license management server 3 (also called the license server 3 hereunder where appropriate) provides license management of the application carried by the client PC 4, performing a license issuing process or a license returning process as requested by the client PC 4 through the network 2. A database 10, connected to the license server 3, stores diverse information on license issuance. According to this embodiment of the invention, the database 10 stores a license pool 11, an overdraft counter 12, and an overdraft history 13 as the information about the issuance of licenses.

The license pool 11 indicates the value representing the number of licenses available until a maximum number of previously purchased licenses are exhausted. Whenever one of the previously purchased licenses is issued by the license server 3, the value held in the license pool 11 is updated. The overdraft counter 12 indicates the value representing the number of licenses issued after the previously purchased licenses have been exhausted. Whenever a license is issued by the license server 3 in excess of the number of the previously purchased licenses, the value held on the overdraft counter 12 is updated. The overdraft history 13 is a history of the overdraft counter 12 recording a history of the licenses issued after the previously purchased licenses have been exhausted.

The network 2 permits communications between the connected devices using a suitable protocol such as TCP/IP (Transmission Control Protocol/Internet Protocol).

How licenses are managed by this embodiment of the invention will now be explained. According to this embodiment, as mentioned above, a license is needed whenever the application is utilized on the client PC 4. Licenses are managed by the license server 3, and the information about the licenses is stored on the database 10. When utilizing the application, the client PC 4 requests the license server 3 to issue a license. In response to the license issuance request from the client PC 4, the license server 3 issues the license.

Suppose that where all licenses managed by the license server 3 have been issued, a request is made of the license server 3 to issue another license. In such a case, no further license can be issued by traditional systems. According to this embodiment of the invention, by contrast, licenses can be issued in excess of the number of the previously purchased licenses.

The license server 3 issues two kinds of licenses: ordinary licenses that have been purchased beforehand, and overdraft licenses that may be issued after all ordinary licenses have been issued. Upon receipt of a license issuance request from the client PC 4, the license server 3 references the value of the license pool 11 stored on the database 10. If the ordinary licenses are found to be still available based on the value of the license pool 11, the license server 3 issues an ordinary license. If the ordinary licenses are found exhausted, an overdraft license is issued.

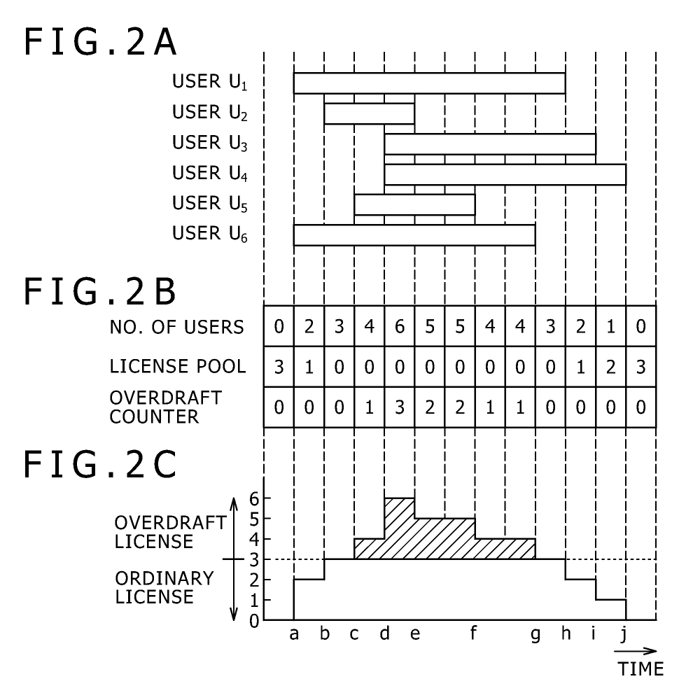

Given below is a more specific explanation of what takes place in reference to FIGS. 2A through 2C. Suppose that three licenses are purchased beforehand as the ordinary licenses and that a plurality of users U₁ through U₆ exceeding the number of the previously purchased ordinary licenses are to utilize the application. FIG. 2A shows changes in application usage status involving the users U₁ through U₆. FIG. 2B indicates those values in the license pool 11 and on the overdraft counter 12 which vary depending on the number of users using the application. FIG. 2C gives the numbers of licenses being issued at predetermined intervals. This example shows that an ordinary license is issued when the number of issued licenses is three or less and that an overdraft license is issued when the number of issued licenses is larger than three.

The values in the license pool 11 and on the overdraft counter 12 vary with the number of users utilizing the application. These values may be calculated using the expressions (1) and (2) given below. It should be noted that the minimum value of the license pool 11 and on the overdraft counter 12 is zero.

License pool 11=number of ordinary licenses−number of licenses in use (1)

Overdraft counter 12=number of licenses in use−number of ordinary licenses (2)

Where no user is utilizing the application, none of the ordinary licenses is being issued. In that case, the license pool 11 holds the value “3,” the maximum number of purchased licenses. Because overdraft licenses have yet to be issued, the overdraft counter 12 holds the value “0.”

At a point in time “a,” the users U₁ and U₆ start using the application. At this point, the license server 3 references the license pool 11 based on a license issuance request from each of the users U₁ and U₆. When the license pool 11 is found to have the value “3,” the license server 3 determines that ordinary licenses are available and issues an ordinary license to each of the users U₁ and U₆. The license server 3 then subtracts the number of issued licenses (i.e., 2) from the current value of the license pool 11 and writes the resulting difference “1” to the license pool 11.

At a point in time “b,” the user U₂ starts using the application. At this point, the license server 3 references the license pool 11 based on a license issuance request from the user U₂. When the license pool 11 is found to have the value “1,” the license server 3 determines that an ordinary license is available and issues that license to the user U₂. The license pool 11 then subtracts “1” from the current value of the license pool 11 and writes the resulting difference “0” to the license pool 11.

At a point in time “c,” another user U₅ starts using the application. At this point, the license server 3 references the license pool 11 based on a license issuance request from the user U₅. When the license pool 11 is found to have the value “0,” the license server 3 determines that the ordinary licenses have been exhausted. Under the traditional license purchasing system, no more licenses can be issued to the user U₅ because the ordinary licenses have been exhausted. According to this embodiment of the invention, by contrast, an overdraft license different from the ordinary licenses is issued to the user U₅. The license server 3 then adds the value “1” (i.e., number of overdraft licenses issued) to the current value of the overdraft counter 12 and writes the resulting sum “1” to the overdraft counter 12.

At a point in time “d,” more users U₃ and U₄ start using the application. At this point, as at the point in time “c,” the license server 3 references the license pool 11 based on license issuance requests from the users U₃ and U₄. When the license pool 11 is found to have the value “0,” the license server 3 determines that the ordinary licenses have been exhausted and issues an overdraft license to each of the users U₃ and U₄. The license server 3 then adds the value “2” to the current value of the overdraft counter 12 and writes the resulting sum “3” to the overdraft counter 12.

At a point in time “e,” the user U₂ stops using the application. At this point, the license server 3 references the overdraft counter 12 based on a license return request from the user U₂. When the overdraft counter 12 is found to have the value “3,” the license server 3 determines that overdraft licenses have been issued and gives the user U₂ permission to return the overdraft license. The license server 3 then subtracts the value “1” from the current value of the overdraft counter 12 and writes the resulting difference “2” to the overdraft counter 12.

At a point in time “f,” the user U₅ stops using the application. At this point, as at the point in time “e,” the license server 3 references the overdraft counter 12 based on a license return request from the user U₅ and gives the user U₅ permission to return the overdraft license. The license server 3 then subtracts the value “1” from the current value of the overdraft counter 12 and writes the resulting difference “1” to the overdraft counter 12.

At a point in time “g,” the user U₆ stops using the application. At this point, as at the points in time “e” and “f,” the license server 3 references the overdraft counter 12 based on a license return request from the user U₆ and gives the user U₆ permission to return the overdraft license. The license server 3 then subtracts the value “1” from the current value of the overdraft counter 12 and writes the resulting difference “0” to the overdraft counter 12.

At a point in time “h,” the user U₁ stops using the application. At this point, the license server 3 references the overdraft counter 12 based on a license return request from the user U₁. When the overdraft counter 12 is found to have the value “0,” the license server 3 determines that no overdraft license is being issued and gives the user U₁ permission to return the ordinary license. The license server 3 then adds the value “1” to the current value of the license pool 11 and writes the resulting sum “1” to the license pool 11.

At a point in time “i,” the user U₃ stops using the application. At this point, as at the point in time “h,” the license server 3 references the overdraft counter 12 based on a license return request from the user U₃. The license server determines that no overdraft license is being issued and gives the user U₃ permission to return the ordinary license. The license server 3 then adds the value “1” to the current value of the license pool 11 and writes the resulting sum “2” to the license pool 11.

At a point in time “j,” the user U₄ stops using the application. At this point, as at the points in time “h” and “i,” the license server 3 references the overdraft counter 12 based on a license return request from the user U₄. The license server 3 determines that no overdraft license is being issued and gives the user U₄ permission to return the ordinary license. The license server 3 then adds the value “1” to the current value of the license pool 11 and writes the resulting sum “3” to the license pool 11.

In the manner described above, the license server 3 provides license management by increasing or decreasing the value of the license pool 11 and/or the value of the overdraft counter 11 based on license issuance/return requests from the users.

What follows is an explanation of what takes place when overdraft licenses are used. According to this embodiment of the invention, as discussed above, an overdraft license may be issued after the ordinary licenses have been exhausted so that the application can be used in the same manner as when an ordinary license is being issued. However, if overdraft licenses are allowed to function in exactly the same manner as ordinary licenses, unscrupulous users could use the application solely with overdraft licenses without purchasing the necessary number of ordinary licenses.

This embodiment of the invention circumvents the above problem by setting beforehand an application usage time based on overdraft licenses, i.e., a cumulative time during which the application can be used with overdraft licenses. While the cumulative time of overdraft license usage is being less than a predetermined value, the application is allowed to be used ordinarily. If the cumulative time is found to have exceeded the predetermined value, the issuance of overdraft licenses is stopped and penalties are imposed such as the functionality of the application being restricted and/or the usage of the application itself being inhibited. These measures are intended to prevent the unscrupulous usage of the application through the use of overdraft licenses.

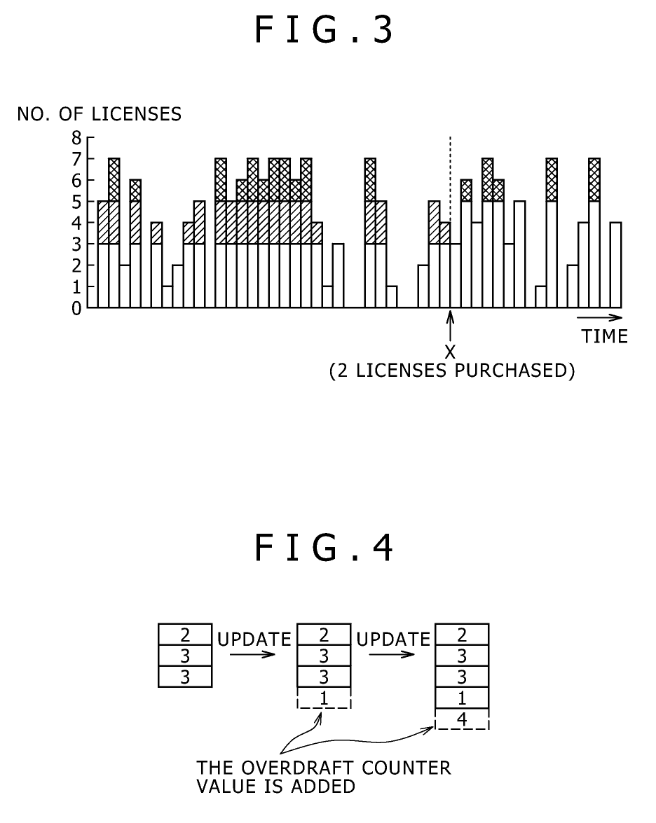

FIG. 3 is a graphic representation showing changes in the number of licenses in use at predetermined intervals, where there are three ordinary licenses available. In the graph of FIG. 3, blank portions indicate use status of the three ordinary licenses, and hatched and double-hatched portions represent use status of overdraft licenses. The hatched portions denote the use of, say, two overdraft licenses. The numbers of overdraft licenses in use indicated by the hatched and double-hatched portions are written to the overdraft counter 12. These values of the overdraft counter 12 are also recorded to the overdraft history 13.

As mentioned above, the overdraft history 13 is a history of the overdraft counter 12. As indicated in FIG. 4, the value of the overdraft counter 12 is added to the overdraft history 13 in a tallying operation performed at predetermined intervals. It should be noted that no value is added to the overdraft history if the value of the overdraft counter 12 is “0,” i.e., if no overdraft license has been issued.

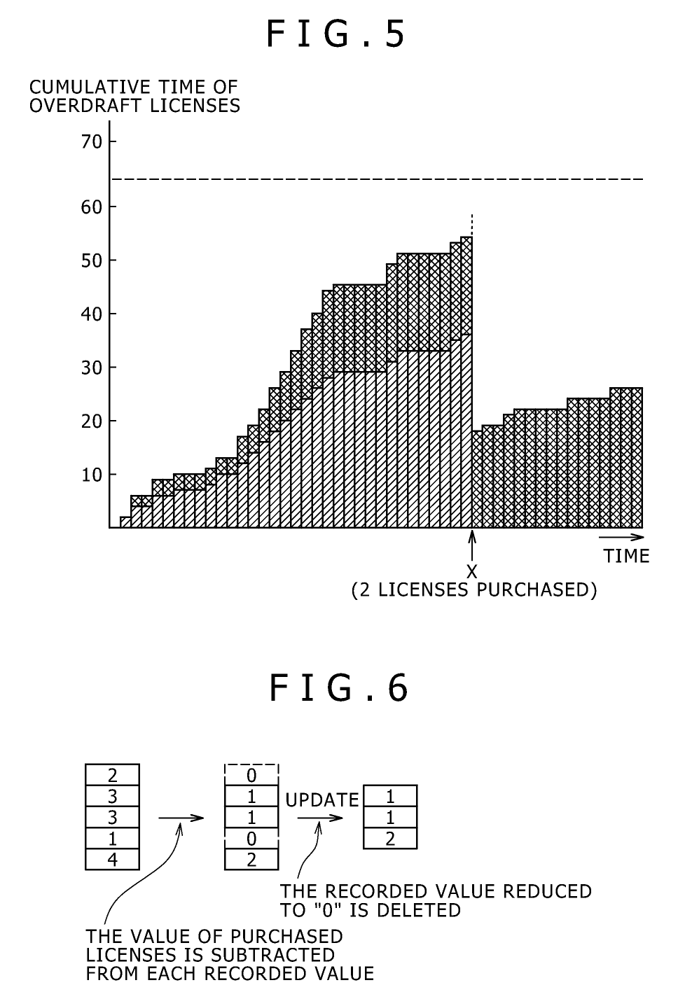

FIG. 5 illustrates typical cumulative time periods tallied at predetermined intervals for overdraft license usage. The graph in FIG. 5 shows the cumulative time periods of overdraft license usage as indicated by the hatched and double-hatched portions of FIG. 3. A broken line in FIG. 5 indicates a threshold value set beforehand on the cumulative time. When the cumulative time reaches the threshold value, the issuance of overdraft licenses is stopped and penalties are imposed such as the usage of the application being restricted. The penalties may include stopping the usage of the application with regard to all licenses and the halt to the usage of the application based on overdraft licenses.

The cumulative time of overdraft license usage as indicated in FIG. 5 is calculated by multiplying the total sum of the recorded values of the overdraft history 13 by predetermined intervals at which the overdraft counter 12 is updated. For example, if the value of the overdraft counter 12 is updated at intervals of one hour, the cumulative time of overdraft license usage is obtained by multiplying the total sum of the values of the overdraft history 12 by one hour.

Where the application has come to be utilized on a constant basis with overdraft licenses, it may be determined that the number of currently purchased ordinary licenses is insufficient. In such a case, an additional number of ordinary licenses may be determined to be purchased. If additional ordinary licenses are purchased anew, the cumulative time of overdraft license usage up to the present is reset with the cumulative time of overdraft license usage corresponding to the newly purchased ordinary licenses.

Illustratively, suppose that three ordinary licenses were previously purchased and that two more ordinary licenses are determined to be purchased anew. In this case, the additional two ordinary licenses may be purchased at a point in time X in FIG. 3. This brings the number of ordinary licenses to five. The two overdraft licenses indicated by the hatched portions are turned into ordinary licenses; only the time of overdraft license usage from the sixth license onward indicated by the double-hatched portions is accumulated.

Also, the additional two ordinary licenses may be purchased anew at a point in time X in FIG. 5. This resets the cumulative time of overdraft license usage up to the present with the cumulative time of two licenses indicated by the hatched portions.

At this point, the number of the newly purchased ordinary licenses is subtracted from each of the recorded values kept in the overdraft history 13. This deletes the history of overdraft license usage corresponding to the newly purchased ordinary licenses from the history of overdraft license usage currently retained in the overdraft history 13.

FIG. 6 shows how the overdraft history 13 is typically updated when two ordinary licenses have been additionally purchased. For example, the number of the newly purchased ordinary licenses (i.e., 2) is subtracted from each of the recorded values kept in the overdraft history 13. If a given recorded value is less than “1,” then that value is regarded as “0.” The recorded values each reduced to “0” are deleted from the overdraft history 13 for an update.

What follows is an explanation of various processes carried out by the license managing system 1 embodying the present invention. The processes to be explained are:
(1) the process to be performed when the application is activated;
(2) the process to be performed when the application is deactivated;
(3) the process of tallying the cumulative time of overdraft license usage; and
(4) the process to be performed when ordinary licenses are additionally purchased.

### (1) Process To Be Performed When the Application is Activated

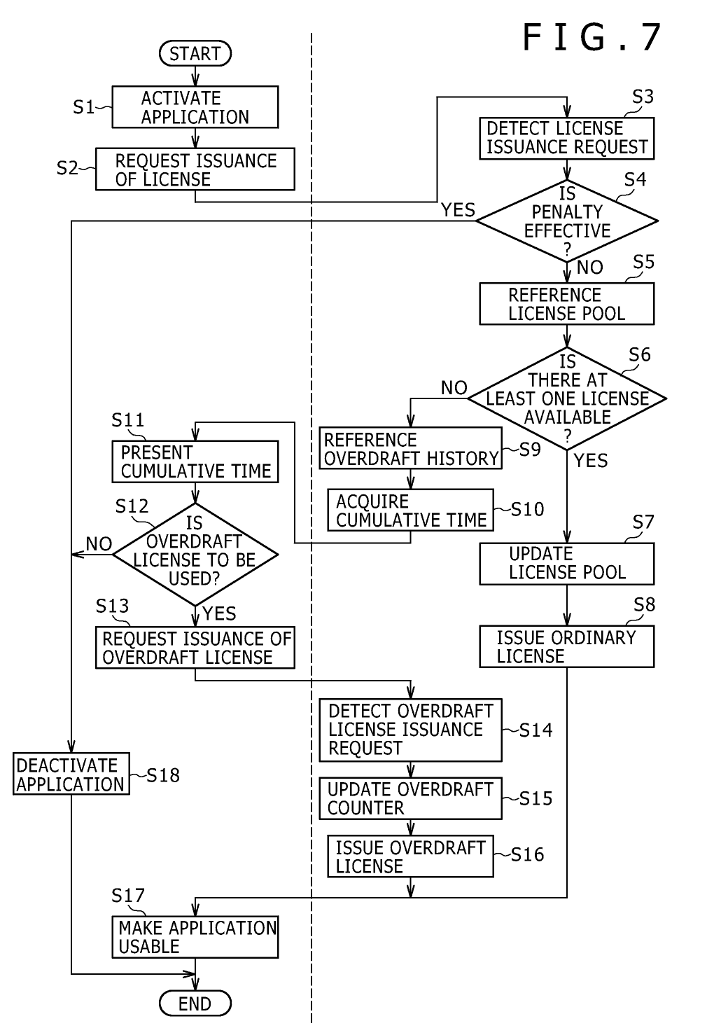

The process to be performed when the application is activated on the client PC 4 is explained below by reference to the flowchart of FIG. 7. In this flowchart, the steps shown on the right side of a central border line (a broken line) constitute a procedure to be carried out by the license server 3, and the steps indicated on the left side of the border line make up a procedure to be executed by the client PC 4.

In step S1, the application is activated on the client PC 4. In step S2, the client PC 4 transmits a license issuance request to the license server 3.

In step S3, the license server 3 detects the license issuance request. In step S4, the license server 3 determines whether the penalties due to overdraft license usage are effective based on the total sum of the recorded values kept in the overdraft history 13. If in step S4 the penalties are not determined to be effective, control is passed on to step S5. In step S5, the license server 3 references the license pool 11 stored on the database 10.

In step S6, the license server 3 determines whether ordinary licenses are still available based on the result of the reference to the license pool 11 in step S5. If the value of the license pool 11 is equal to or larger than “1” (i.e., other than “0”), then ordinary licenses are determined to be available and control is passed on to step S7. In step S7, the license server 3 subtracts “1” from the value of the license pool 11 and writes the resulting difference to the license pool 11 for an update. In step S8, the license server 3 issues an ordinary license and sends it to the client PC 4.

If in step S6 the value of the license pool 11 is determined to be less than “1” (i.e., “0”), then the ordinary licenses are determined to be exhausted, and control is passed on to step S9. In step S9, the license server 3 references the overdraft history 13 stored on the database 10. In step S10, the license server 3 acquires the cumulative time of overdraft license usage from the result of the reference to the overdraft history 13 in step S9, and transmits information indicative of the acquired cumulative time to the client PC 4.

In step S11, the client PC 4 receives the information indicative of the cumulative time and proposes to the user that the application be utilized by use of an overdraft license. The cumulative time of overdraft license usage up to the present is also presented to the user at this point.

In step S12, the user determines whether or not to use an overdraft license on the basis of the information indicating the cumulative time of overdraft license usage. If the user determines to use an overdraft license, then control is passed on to step S13. In step S13, the client PC 4 transmits an overdraft license issuance request to the license server 3.

In step S14, the license server 3 detects the overdraft license issuance request. In step S15, the license server 3 adds “1” to the value of the overdraft counter 12 stored on the database 10 and writes the resulting sum to the overdraft counter 12 for an update. In step S16, the license server 3 issues an overdraft license and sends it to the client PC 4.

In step S17, the application is made usable through the use of the ordinary or overdraft license that has been issued. This brings the entire process to an end.

If in step S4 the penalties are determined to be effective or if in step S12 the user determines that the overdraft license will not be used, then control is passed on to step S18. In step S18, the activation of the application is halted and the entire process is brought to an end.

(2) Process To Be Performed When the Application is Deactivated

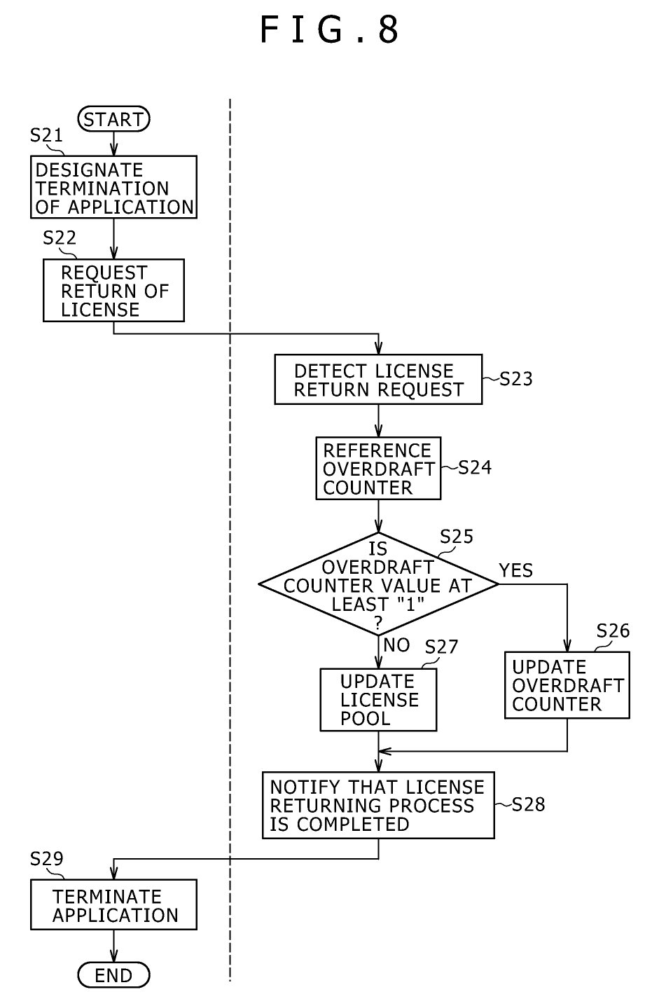

The process to be performed when the application is deactivated on the client PC 4 is explained below by reference to the flowchart of FIG. 8. In this flowchart, as in FIG. 7, the steps shown on the right side of a central border line (a broken line) constitute a procedure to be carried out by the license server 3, and the steps indicated on the left side of the border line make up a procedure to be executed by the client PC 4.

In step S21, an instruction is given to deactivate the application on the client PC 4. In step S22, the client PC 4 transmits a license return request to the license server 3.

In step S23, the license server 3 detects the license return request. In step S24, the license server 3 references the overdraft counter 12. In step S25, the license server 3 determines whether any overdraft license has been issued based on the result of the reference to the overdraft counter 12 in step S24. If the value of the overdraft counter is equal to or larger than “1,” overdraft licenses are determined to have been issued and control is passed on to step S26. In step S26, the license server 3 subtracts “1” from the value of the overdraft counter 12 and writes the resulting difference to the overdraft counter 12 for an update.

If in step S25 the value of the overdraft counter 12 is found to be “0,” no overdraft license is determined to have been issued and control is passed on to step S27. In step S27, the license server 3 adds “1” to the value of the license pool 11 and writes the resulting sum to the license pool 11 for an update.

In step S28, the license server 3 notifies the client PC 4 that a license returning process is terminated. In step S29, the client PC 4 receives a completion notice of the license returning process and proceeds to deactivate the application. This brings the entire process to an end.

### (3) Process of Tallying the Cumulative Time of Overdraft License Usage

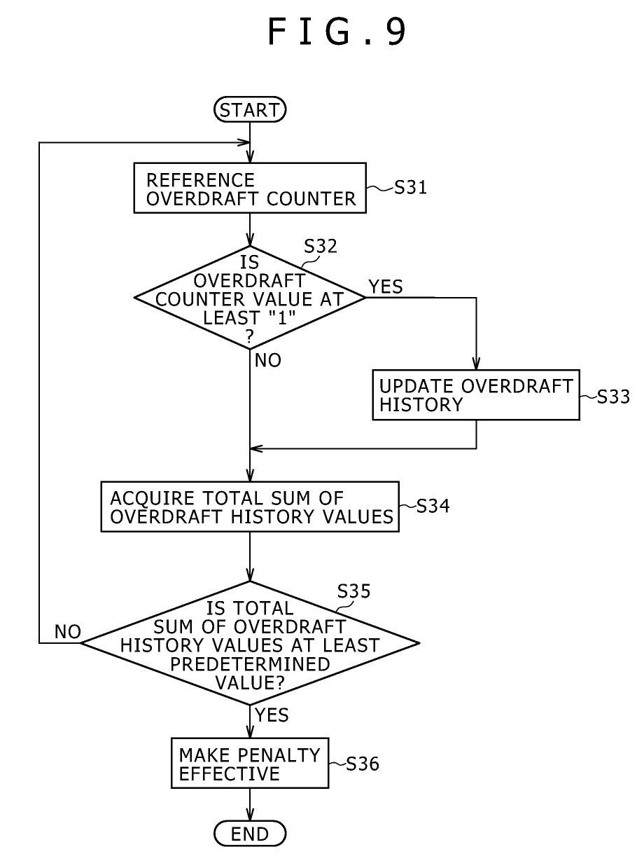

The process of tallying the cumulative time of overdraft license usage is explained below by reference to the flowchart of FIG. 9. The steps in this flowchart are carried out by the license server 3 at predetermined intervals of, say, one hour in a cyclical manner.

In step S31, the license server 3 references the overdraft counter 12 and determines whether any overdraft license has been issued based on the result of the reference. If the value of the overdraft counter 12 is equal to or larger than “1,” then overdraft licenses are determined to have been issued and control is passed on to step S33. In step S33, the license server 3 adds the current value of the overdraft counter 12 to the overdraft history 13 for an update, as shown in FIG. 4.

If the value of the overdraft counter 12 is found to be “0,” the license server 3 determines that no overdraft license has been issued. In that case, control is passed on to step S34.

In step S34, the license server 3 acquires the total sum of the recorded values in the overdraft history 13. In step S35, the license server 3 determines whether the total sum of the recorded values of the overdraft history 13 acquired in step S34 is larger than a predetermined value. If the total sum of the recorded values is determined to be larger than the predetermined value, then control is passed on to step S36. In step S36, the penalties are made effective.

If in step S35 the total sum of the recorded values is determined to be less than the predetermined value, then control is returned to step S31. At the end of the next predetermined interval, the whole process is repeated.

(4) Process To Be Performed when Ordinary Licenses are Additionally Purchased

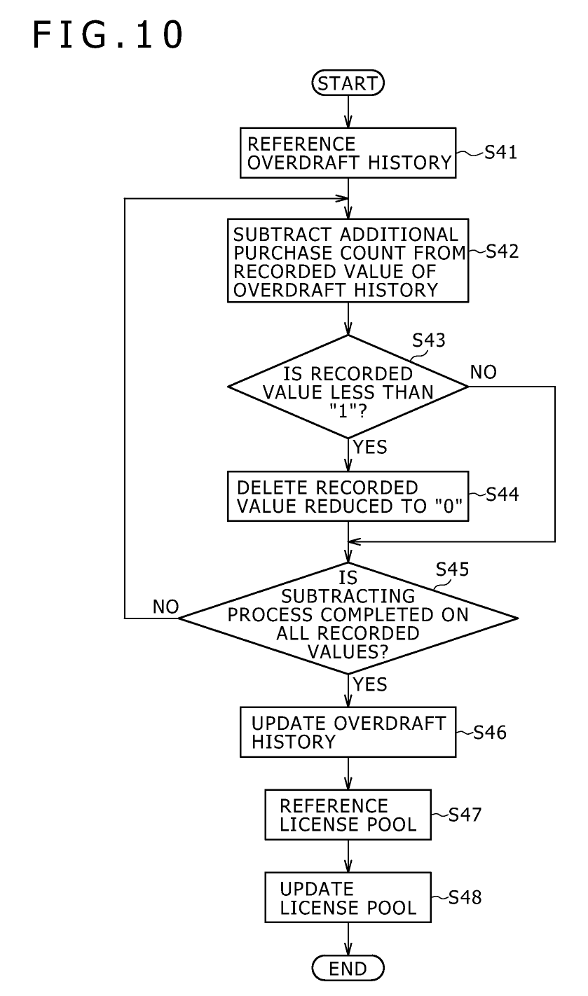

The process to be performed when ordinary licenses are additionally purchased is explained below by reference to the flowchart of FIG. 10. The steps shown in FIG. 10 are carried out by the license server 3. This process is started when an ordinary license or licenses are purchased anew and the license server 3 has completed authorization of the additionally purchased ordinary licenses.

In step S41, the license server 3 references the overdraft history 13. In step S42, the license server 3 subtracts the number of additionally purchased ordinary licenses from one of the recorded values kept in the overdraft history 13.

In step S43, the license server 3 determines whether the recorded value calculated in step S42 is less than “1.” If the recorded value is found to be less than “1” (i.e., 0), then control is passed on to step S44. In step S44, the recorded value being reduced to “0” is deleted from the overdraft history 13. If the recorded value is found equal to or larger than “1,” then control is passed on to step S45.

In step S45, the license server 3 determines whether the subtracting procedure formed by steps S42 through S44 has been performed on all recorded values kept in the overdraft history 13. If the subtracting procedure is found to have been carried out on all recorded values, control is passed on to step S46. If the subtracting procedure has yet to be executed on all recorded values, control is returned to step S42, and step S42 is carried out on the next recorded value.

In step S46, each of the recorded values retained in the overdraft history 13 is replaced with the corresponding value calculated in step S42; the overdraft history 13 is updated accordingly.

In step S47, the license server 3 references the license pool 11. In step S48, the license server 3 adds the number of the additionally purchased ordinary licenses to the maximum value of ordinary licenses kept in the license pool 11. This brings the entire process to an end.

According to this embodiment of the invention, as described above, if a request is made for the issuance of a new license after all ordinary licenses have been issued, then an overdraft license is issued. Thanks to this arrangement, there is no need to pay extra compensation for the usage of overdraft licenses even where the application is to be used after all ordinary licenses have been exhausted.

The cumulative time of overdraft license usage is tallied, and a maximum usable cumulative time is set beforehand on the issuance of overdraft licenses. If overdraft licenses are used beyond the maximum usable cumulative time, penalties are imposed such as a halt to the use of the application. This feature is intended to prevent the unscrupulous utilization of the application through the use of overdraft licenses.

Also, when ordinary licenses are purchased anew, the cumulative time of overdraft license usage up to the present is reset with the cumulative time of overdraft license usage corresponding to the additionally purchased ordinary licenses. That is, the cumulative time of overdraft license usage up to the present is reset not as a whole but in a manner dependent on the cumulative time of overdraft license usage corresponding to the additionally purchased ordinary licenses. With the calculated cumulative time thus reset in suitably varied fashion, it is possible to prevent unfair apportioning of the cumulative time due to the excessive use of the newly purchased ordinary licenses.

While one preferred embodiment of this invention has been described using specific terms, such description is for illustrative purposes only, and it is to be understood that changes and variations may be made without departing from the spirit or scope of the claims that follow. For example, although the above-described embodiment was shown tallying the cumulative time of overdraft license usage at predetermined intervals, this is not limitative of the present invention.

Illustratively, there may be cases in which overdraft licenses are issued and then returned after a tallying process is completed and before the next tallying process is started. In such cases, there is no way of detecting the issuance of overdraft licenses, so that it is impossible to calculate the cumulative time of overdraft license usage. This bottleneck is circumvented illustratively by carrying out the process of tallying the cumulative time of overdraft license usage whenever an overdraft license or licenses are issued and returned. This arrangement will make sure that the cumulative time of overdraft license usage is calculated with far fewer omissions than before.

What is claimed is:

1. A license managing apparatus comprising:
a license management section configured to issue a license in response to a request from an external device carrying an application to be activated using said license;
a database configured to store ordinary license information indicating the number of ordinary licenses yet to be issued until a predetermined maximum number of ordinary licenses being held are exhausted, and overdraft license information indicating the number of overdraft licenses issued after said ordinary licenses have been exhausted; and
a transmission section configured to transmit said license issued for said external device, wherein
upon receipt of a license issuance request from said external device, said license management section references said ordinary license information to determine whether said ordinary licenses are still available,
if said ordinary licenses are determined to be available, then said license management section decrements said ordinary license information numerically by 1 and issues one ordinary license to said external device via said transmission section, and
if said ordinary licenses are determined to have been exhausted, then said license management section increments said overdraft license information numerically by 1 and issues one overdraft license to said external device via said transmission section.

2. The license managing apparatus according to claim 1, wherein:
said database further stores overdraft history information indicating a history of values of said overdraft license information at predetermined intervals;
said license management section references said overdraft license information at said predetermined intervals and, if the value of said overdraft license information is currently at least 1, adds the current value of said overdraft license information to said overdraft history information; and
based on the total sum of the values of said overdraft history information, said license management section calculates a cumulative time during which said overdraft licenses have been used.

3. The license managing apparatus according to claim 2, wherein, when ordinary licenses are added, said license management section subtracts the number of the added ordinary licenses from all values recorded in said overdraft history information, and updates said overdraft history information.

4. The license managing apparatus according to claim 3, wherein, when ordinary licenses are added, said license management section adds the number of the added ordinary licenses to the maximum number of said ordinary license information, and updates said ordinary license information.

5. The license managing apparatus according to claim 2, wherein, when the cumulative time calculated on the basis of the total sum of the values of said overdraft history information exceeds a predetermined threshold value, said license management section stops issuing said overdraft licenses.

6. The license managing apparatus according to claim 2, wherein, if said ordinary licenses are determined to have been exhausted upon receipt of a license issuance request from said external device, then said license management section transmits information indicating the calculated cumulative time to said external device via said transmission section.

7. The license management apparatus according to claim 1, wherein:
upon receipt of a license return request from said external device, said license management section references said overdraft license information to determine whether said overdraft licenses have been issued;
if one overdraft license is determined to have been issued, then said license management section decrements said overdraft license information numerically by 1 for an update;
if said overdraft licenses are not determined to have been issued, then said license management section increments said ordinary license information numerically by 1 for an update; and
said license management section notifies said external device that a license returning process is completed.

8. A license managing method comprising the steps of:
issuing a license in response to a request from an external device carrying an application to be activated using said license, by referencing a database configured to store ordinary license information indicating the number of ordinary licenses yet to be issued until a predetermined maximum number of ordinary licenses being held are exhausted, and overdraft license information indicating the number of overdraft licenses issued after said ordinary licenses have been exhausted; and
transmitting said license issued for said external device, wherein
upon receipt of a license issuance request from said external device, said license managing step references said ordinary license information to determine whether said ordinary licenses are still available,
if said ordinary licenses are determined to be available, then said license managing step decrements said ordinary license information numerically by 1 and issues one ordinary license to said external device, and
if said ordinary licenses are determined to have been exhausted, then said license managing step increments said overdraft license information numerically by 1 and issues one overdraft license to said external device.

9. A license managing system comprising
a device, and
a license managing apparatus, wherein:
said device includes
a section configured to request issuance of a license needed to use an application carried by said device, and
a first transmission section configured to transmit the license issuance request;
said license managing apparatus includes
a license management section configured to issue a license in response to the request from said device,
a database configured to store ordinary license information indicating the number of ordinary licenses yet to be issued until a predetermined maximum number of ordinary licenses being held are exhausted, and overdraft license information indicating the number of overdraft licenses issued after said ordinary licenses have been exhausted, and
a second transmission section configured to transmit said license issued for said external device;
upon receipt of a license issuance request from said external device, said license management section references said ordinary license information to determine whether said ordinary licenses are still available;
if said ordinary licenses are determined to be available, then said license management section decrements said ordinary license information numerically by 1 and issues one ordinary license to said external device via said second transmission section; and
if said ordinary licenses are determined to have been exhausted, then said license management section increments said overdraft license information numerically by 1 and issues one overdraft license to said external device via said second transmission section.
